(19) United States
(12) Patent Application Publication
(10) Pub. No.: US 2006/0139490 A1
(43) Pub. Date: Jun. 29, 2006

(54) Synchronizing audio with delayed video

(76) Inventors: Wilhelmus Franciscus Fekkes, Beek En Donk (NL); Michel Wouter Nieuwenhuizen, Eindhoven (NL); Johan Marie Spanjers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 11/302,903

(22) Filed: Dec. 14, 2005

Related U.S. Application Data
(60) Provisional application No. 60/636,366, filed on Dec. 15, 2004.

(51) Int. Cl. H04N 9/475; H04N 5/45; H04N 5/05; H04N 9/455

(52) U.S. Cl. 348/515; 348/524

(57) ABSTRACT

Video processing delays are compensated for to maintain synchronism of audio with the video. The delay is determined by correlating a signal derived from a displayed light image with a pre-processed video test signal from which the image was produced.

Video display apparatus, such as television and monitor equipment, includes complex video processing circuitry and software to process the video component of a video signal. This processing generally imposes delays in the transmission of the video component that are substantially longer than any delays imposed on the audio component of the video signal and can adversely affect the synchronism between the audio and video presented to the viewer.

When the audio and video components both pass through a common apparatus, it is possible to maintain synchronism by adding a compensating transmission delay to the audio component. However, in cases where both of these components do not pass through a common apparatus, such compensation is not easily achieved. For example, if a DVD player is the source of the video signal, the video and audio components might pass through different audio and video equipments, where the manufacturer of the audio equipment does not know the duration of the processing delay in the video component.

In accordance with the invention, compensation for loss of synchronization between video and audio, because of a video signal processing delay, is achieved by transmitting a video test signal representing a test image to be presented by a display device. The video test signal is subjected to the processing delay, before the test image is presented. A light detector receives light from the test image and produces a received test signal representative of the test image. A delay of the audio to compensate for the video processing delay is effected by means of a controller. The controller determines the delay needed by correlating the received test signal with the transmitted test signal.

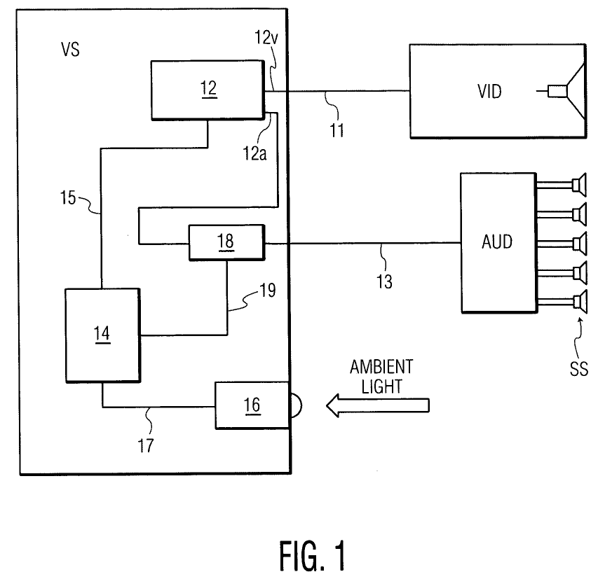

FIG. 1 is a block diagram illustrating an exemplary embodiment of a video system including processing delay compensation.

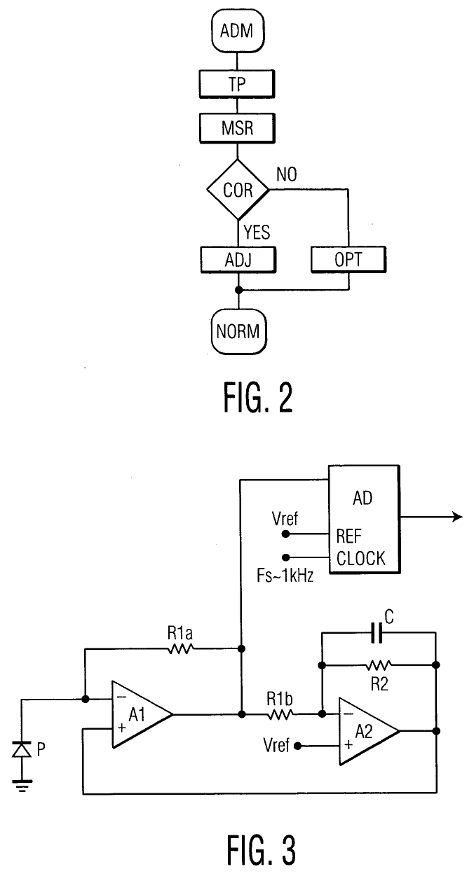

FIG. 2 is a flow diagram illustrating an exemplary embodiment of a delay compensation method.

FIG. 3 is a schematic illustration of an exemplary embodiment of a light detector for use in the video system.

The video system of FIG. 1 includes a video source VS coupled to an audio device AUD and a display device VID. The video source VS can be any device that provides a video signal, e.g. a DVD player or a satellite receiver. The audio device AUD can be part of the video source or a separate piece of equipment, e.g. an audio receiver for driving a speaker system SS. The display device VID can be a television or monitor or other equipment for displaying video images.

The video source VS includes a video generator 12, e.g. an MPEG decoder, for supplying a video signal having a video component, provided at an output 12v, and an audio component, provided at an output 12a. These components may be provided in the form of either digital or analog signals, as is well known in the art.

The video component provided at output 12v is transmitted over a line 11 to the display device VID, where a video processing delay occurs before the image represented by the video component is displayed to the viewer. This delay typically includes a number of smaller cumulative delays including, for example, processing for noise reduction, complex (e.g., three-dimensional) scaling, application of natural-motion algorithms, and varies with the type of display device (e.g., Plasma, LCD, DMD, CRT). The duration of the delay in the display device may be unknown to the manufacturer of the video source VS, particularly if these equipments are from different manufacturers.

The audio component provided at output 12a of the video generator 12 is transmitted through an audio delay device 18 having a controllable variable delay, and then over a line 13 to the audio device AUD.

The video source VS further includes a controller 14 (e.g., a micro-controller), a light detector 16, and a test signal generator (which is advantageously incorporated in the video generator 12) for collectively determining the duration of the delay imposed on the video component. The controller 14 is coupled to the video generator 12, via a line 15, for receiving a test signal produced by the test signal generator.

When activated, the test signal generator simultaneously transmits a video test signal over the lines 11 and 15 to the display device VID and to the controller 14, respectively. If the video source includes an MPEG decoder, it can be set to produce video test signals representing one or more desired test patterns for display by the display device. In an exemplary embodiment, the test generator produces a video test signal representing a sequence of alternating darker and lighter images, such as solid black and white screens, to be produced by the display device.

The light detector 16 is located to receive the ambient room light including light from the test pattern produced by the display device VID. The light detector converts the received light to a detection signal, which is influenced by light from the displayed test pattern. Specifically, the detection signal includes a test signal component (the “received test signal”) representing the test pattern and transmits it via a line 17 to the controller 14.

The controller 14 operates to determine the delay that must be provided by the audio delay device 18 to place the audio from the speaker system in synchronism with the image displayed by the device VID. In order to do this, controller 14 measures the delay between the transmission of the video test signal and the reception of the test signal, representing the test pattern produced by the display device VID. The controller then transmits a delay signal representing the measured delay over a line 19 to audio delay device 18, which effects a corresponding delay of the audio signal transmitted to the audio device AUD. Note that the audio delay device 18 need not be a separate apparatus. For example, if the video generator 12 incorporates an MPEG decoder, the desired delay can be effected by, for example, manipulating timestamps in the MPEG program stream.

FIG. 2 illustrates an exemplary process for operating the video system of FIG. 1 to compensate for the undesirable delay of the video relative to the audio presented to a viewer. A typical example of the negative consequences of such a delay is a loss of lip synch of a speaking person in the displayed image. This loss is easily noticeable with a video delay of as little as, for example, one-tenth of a second or less.

Referring to FIG. 2:
At ADM, an audio delay measuring mode is entered to begin the process of compensating for any delay of the video relative to the audio presented to the viewer. Conveniently this would be done as part of a set-up program that can be performed by the controller 14 when the system is installed or at any other desired time.
At TP, the controller 14 transmits over line 15 a signal ordering the test signal generator in video generator 12 to begin transmitting the video test signal over lines 11 and 15. (Alternatively, line 15 need only pass to the controller 14 the timing of the test pattern represented by the video test signal.) Optionally, the test signal generator may be elsewhere in the system, and may even be incorporated in the controller itself. The repetition rate of the test pattern (e.g., alternating black and white full screen images) is preferably long in comparison to the longest delay expected. To avoid ambiguity, the cycle of the full test-pattern sequence is at least twice the longest expected delay.
At MSR, the controller begins sampling the detection signal produced by the detector 16. Sampling should begin in a time period shorter than the minimum expected delay time effected by the video processing. The sampling interval should be at least as small as the desired accuracy of measurement of the video processing delay. For example, for a good apparent lip synch, as observed by a typical viewer, an accuracy of about 10 milliseconds is desirable. In an exemplary system, such an accuracy was readily obtained by using a pattern of alternating black and white full screen images, each having a duration of about 1.0 second and by sampling at an interval of about 1 to 5 milliseconds. Sampling continues for a period that is long enough to correlate the received test signal carried by the received detection signal with the transmitted video test signal. The exemplary system had a sampling period of several seconds, during which the controller attempts to correlate black-to-white and white-to-black transitions detected in the detection signal with corresponding transitions in the transmitted video test signal. The algorithm used by the controller can be very simple to very complex, depending on the desired capability of the extraction of the detected pattern from a noisy received test signal.
At COR, the controller determines whether the correlation was successful. Correlation will not be possible if the light from the test pattern is not clearly distinguishable from the ambient light itself. This can happen under adverse light conditions, for example, if sunlight shines directly on a light sensor of the light detector or if the intensity of the ambient light is varying similarly to that of the test pattern. If correlation is successful, the next step in the process will be ADJ; if not, it will be OPT.
At ADJ, following successful correlation, the controller determines the time delay between the transmitted test signal and the received test signal. The controller then correspondingly adjusts the delay provided by the audio delay device 18 to bring the audio produced by audio device AUD in synch with the video image presented by the display device VID.
At OPT, the controller transmits a message via the video generator 12 to the display device VID advising the viewer that the synchronizing process was not successful. The message may also suggest corrective actions for improving the ambient light conditions, such as darkening the room or relocating the ambient light sensor relative to the display device or providing a reflective surface for increasing the light directed from the display and onto the light detector 16. Depending on the capability of the video source S to intelligently communicate with a remote control, further options can be explained by messages from the controller. For example, the viewer can be guided through a manual adjustment to synchronize the audio and video while watching the screen image, e.g. by selecting a delay from a number of predetermined default settings covering a range of probable delays for known display devices.
At NORM, following both ADJ and OPT, the controller 14 returns the video source to its normal mode of operation.

FIG. 3 illustrates an exemplary embodiment of the light detector 16. Although design of a variety of such light detectors is well within the skill of the art, this embodiment demonstrates that such a detector can be made at relatively low expense components with a few simple components. The light detector includes a first amplifier circuit including a photo-diode P, operational amplifier A1 and resistors R1a, R1b; a second amplifier circuit including operational amplifier A2, resistor R2, and capacitor C; and an A/D converter AD.

The photo-diode P is disposed where it will sense the ambient light in the area where the display device VID is operative. Conveniently it will be incorporated in a housing of the video source VS or other component containing the light detector, but it may also be remotely located. The current passing through the photodiode varies as a function of the incident light. The first amplifier circuit primarily functions to convert the photodiode current to an amplified voltage representative of the incident light intensity. The second amplifier circuit functions as both a comparator and an integrator. It cooperates with the first amplifier circuit to keep the first amplifier in its linear operating range. An inexpensive low-conversion speed A/D converter may be utilized because both resolution and conversion speed may be low. The A/D converter in this exemplary light detector operates at a conversion clock rate of 1 kHz.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

What is claimed is:

1. Apparatus for compensating for loss of synchronization between video and audio presented to a viewer due to a processing delay of the video, said apparatus comprising:
a. a signal 12 generator for transmitting a test signal representing a test image to presented by a display device after said test signal is subjected to said processing delay;
b. a light detector 16 for receiving light from the test image and producing a received test signal representative of the test image;
c. a controller 14 for: i) correlating the received test signal with the transmitted test signal, ii) determining the delay between said signals, and iii) effecting a compensating delay of the audio.

2. Apparatus as in claim 1 where the light detector receives ambient light including the light from the test image.

3. Apparatus as in claim 1 where the test image comprises a test pattern.

4. Apparatus as in claim 3 where the test pattern comprises alternating darker and lighter images.

5. Apparatus as in claim 1 where the test image comprises a series of images, said series repeating at an interval that is at least twice as long as the processing delay.

6. A video source VS for providing a video output and an audio output and comprising:
a. a test generator 12 for effecting production of a test image by a display device;
b. an ambient light detector 16 for receiving and detecting ambient light including light from the test image;
c. an audio delay device 18 for effecting a controllable delay in the audio output;
d. a controller 14 for: i) receiving an output of the test generator 12 that represents the test image to be produced, ii) receiving an output of the ambient light detector 16 that represents the detected test image, iii) producing an audio delay signal representing a video delay between the output from the test generator 12 and the output from the ambient light detector, and iv) controlling the audio delay device 18 to delay the audio output so as to compensate for said video delay.

7. A video source as in claim 6 where the test image comprises a test pattern.

8. A video source as in claim 7 where the test pattern comprises alternating darker and lighter images.

9. A video source as in claim 6 where the test image comprises a series of images, said series repeating at an interval that is at least twice as long as the video delay.

10. A synchronization system comprising:
a. a video source for providing a video output and an audio output;
b. a test image generator 12 for producing as the video output a test signal representative of a test image for display by a display device;
c. a light detector 16 for detecting light from the test image and producing a signal indicating detection of the test image;
d. an audio delay device 18 for controllably delaying the audio output;
e. a controller 14 for: i) receiving the test signal and the signal from the light detector 16, ii) determining a delay in production of the test image by the display, and iii) effecting a compensating delay in the audio output.

11. A synchronization system as in claim 10 where the light detector receives ambient light including the light from the test image.

12. A synchronization system as in claim 10 where the test image comprises a test pattern.

13. A synchronization system as in claim 12 where the test pattern comprises alternating darker and lighter images.

14. A synchronization system as in claim 10 where the test pattern comprises a series of images, said series repeating at an interval that is at least twice as long as the delay determined by the controller.

15. A method of compensating for loss of synchronization between video and audio presented to a viewer due to a processing delay of the video, said method comprising:
a. transmitting a test signal representing a test image to be presented by a display device after said test signal is subjected to said processing delay;
b. detecting light from the test image and producing a received test signal representative of the test image;
c. determining the delay between said signals and effecting a compensating delay of the audio.

16. A method as in claim 15 where the detected light is ambient light including the light from the test image.

17. A method as in claim 15 where the test image comprises a test pattern.

18. A method as in claim 17 where the test pattern comprises alternating darker and lighter images.

19. A method as in claim 15 where the test image comprises a series of images, said series repeating at an interval that is at least twice as long as the processing delay.
